(19) United States
(12) Patent Application Publication
(10) Pub. No.: US 2010/0167590 A1
(43) Pub. Date: Jul. 1, 2010

(54) Contact Assembly, Method for Manufacturing Contact Assembly, and Electrical Connector

(76) Inventor: Masaaki Iwasaki, Kanagawa (JP)

Correspondence Address: BARLEY SNYDER, LLC, 1000 WESTLAKES DRIVE, SUITE 275, BERWYN, PA, 19312, US

(21) Appl. No.: 12/095,600

(22) PCT Filed: Oct. 23, 2006
(86) PCT No.: PCT/JP2006/321021

§ 371 Date: May 30, 2008

(30) Foreign Application Priority Data
Nov. 30, 2005 (JP) 2005-346743

(51) Int. Cl. H01R 24/00; H01R 43/04

(52) U.S. Cl. 439/626; 29/882

(57) ABSTRACT

An electrical connector and a method of manufacturing an electrical connector include a contact assembly including an inner housing and a plurality of contacts. The inner housing has a plurality of contact press-fitting openings. Each of the contacts has an elastic contact member for electrically connecting to a card inserted into the electrical connector and a press-fitting member. The press-fitting member is inserted into the contact press-fitting openings in a direction perpendicular to a direction of pressing of the elastic contact members by the card.

### CROSS-REFERENCE TO RELATED APPLICATIONS

This application claims the benefit of the filing date under 35 U.S.C. §120 of PCT International Patent Application No. PCT/JP2006/321021 filed Oct. 23, 2006 that claims the benefit of Japanese Patent Application No. 2005-346743 filed Nov. 30, 2005.

### FIELD OF THE INVENTION

The present invention relates to a contact assembly comprising an inner housing and a plurality of contacts, a method for manufacturing the contact assembly, and an electrical connector comprising the contact assembly.

### BACKGROUND

In recent years, mini SD cards which are such that the external shape of SD memory cards is reduced have been used in electronic devices such as portable telephones, telephones, portable audios, personal digital assistances (PDAs), gaming devices, cameras, and information terminal devices.

With such mini SD cards, because the external shape is small compared to SD cards, in order to connect a mini SD card to a socket for an SD card, a card adaptor is required which electrically connects the mini SD card and the socket for an SD card by holding the mini SD card while being connected to the socket for an SD card.

The card adaptor shown in FIGS. 21A through 23 (see JP2005-242448A), for example, has been known in the past as a card adaptor of this type for connecting a small card such as a mini SD card to a socket for a large card. The card adaptor 101 shown in FIGS. 21A through 23 is constructed from a contact assembly 106 comprising a plurality of contacts 105 and an inner housing 104 that holds the plurality of the contacts 105 in parallel to each other and an upper case 102 and a lower case 103 that accommodate this contact assembly 106. Furthermore, the contact assembly 106 is formed by insert-molding. Moreover, as is shown in FIGS. 22 and 23, each of the contacts 105 comprises an elastic contact member 105a that contacts a conductor pad of a small card C such as a mini SD card, and a terminal member 105b that is connected to a socket for a large card; such a contact 105 is formed by stamping and forming a metal plate. In addition, a card insertion slot 107 into which the small card C is inserted is formed in the front end portion (lower end portion in FIG. 21A) of the card adaptor 101.

In the assembly of the card adaptor 101, a contact assembly 106 comprising the plurality of the contacts 105 and the inner housing 104 is first formed by insert-molding as shown in FIG. 23. Next, the contact assembly 106 is placed on the lower case 103 and fastened in place as shown in FIG. 22. Finally, the upper case 102 is placed over the lower case 103 as shown in FIG. 21A, and a plurality of fusion members 102a provided on the upper case 102 are fusion-bonded by ultrasonic welding or the like. As a result, a card adaptor 101 is completed.

In the card adaptor 101, however, because the contact assembly 106 is formed by insert-molding, a mold for performing this insert-molding is complicated, so that there is a problem in that the manufacturing cost becomes high. Furthermore, a resin for forming the inner housing 104 is required to perform insert-molding, but a resin with a large shrinkage rate cannot be selected in the molding, creating the problem of difficulty in the resin selection.

Moreover, the contact pressure against the elastic contact members 105a by the conductive pads provided on the small card C is dependent upon the gap for the insertion of the small card C between the elastic contact members 105a and the upper surface of the lower case 103 that faces the elastic contact members 105a; if this gap is large, the contact pressure is small, and if the gap is small, the contact pressure is large. Accordingly, it is necessary to control the gap at an appropriate value. In the insert-molding, however, due to the restriction of the mold, the lower case 103 that faces the elastic contact members 105a cannot be manufactured simultaneously, so that it is difficult to control the gap between the elastic contact members 105a and the upper surface of the lower case 103 at an appropriate value. Therefore, variance tends to be generated in the contact pressure against the elastic contact members 105a by the conductive pads provided on the small card C, so that there is a danger that the electrical connection between the small card C and the card adaptor 101 cannot be established properly.

Meanwhile, the card adaptor shown in FIGS. 24 and 25 (see JP2004-252672A), for example, has also been known as another example of a card adaptor for connecting a small card such as a mini SD card to a socket for a large card. The card adaptor 201 shown in FIG. 24 is constructed from a plurality of contacts 206, a lower case 203 which accommodates the plurality of the contacts 206 in the interior and in which the contacts 206 are press-fitted, an upper case 202 that is fastened to the lower case 203, and a protection tab 204. Furthermore, each of the contacts 206 comprises a securing member 206a that is press-fitted into a press-fitting groove 203a in the lower case 203, an elastic contact member 206b that is positioned in a recessed groove 203b in the lower case 203 and that contacts a conductive pad of a small card (not shown in the figures), and a terminal member 206c that is positioned inside a through-hole 203c in the lower case 203 and that is connected to a socket for a large card. Moreover, a card insertion slot 205 into which a small card is inserted is formed in the front end portion (left end portion in FIG. 24) of the card adaptor 201.

In the assembly of the card adaptor 201, as shown in FIG. 25, a contact member 210 is first manufactured by stamping and forming a metal plate, with the contact member 210 being formed by connecting adjacent contacts 206 to each other by linking pieces 209 and connecting the linking pieces 209 and a carrier 207 by the connecting pieces 208.

Next, the securing members 206a of the plurality of the contacts 206 are respectively press-fitted into the press-fitting grooves 203a in the lower case 203 from above, the elastic contact members 206b of the contacts 206 are respectively positioned in the recessed grooves 203b in the lower case 203, and the terminal members 206c of the contacts 206 are respectively positioned inside the through-holes 203c in the lower case 203. Then, the linking pieces 209 are cut to separate the adjacent contacts 206 from each other, and the connecting pieces 208 are cut to separate the carrier 207 from the linking pieces 209.

Finally, the upper case 202 is placed over the lower case 203, and a plurality of fusion members (not shown in the figures) provided on the upper case 202 are fusion-bonded to the lower case 203 by ultrasonic welding or the like. As a result, the card adaptor 201 is completed.

Furthermore, a small card is inserted from the card insertion slot 205 in the front end portion of the card adaptor 101 toward the rear, and the conductive pads formed on the undersurface of the small card respectively make contact with the elastic contact members 206b of the contacts 206 from above, and press the elastic contact members 206b downward.

In the card adaptor 201, because the plurality of the contacts 206 are designed to be press-fitted in the lower case 203, there is no need for insert-molding, and the mold is simple, so that the manufacturing cost can be lowered. Moreover, because insert-molding is not required, there is no problem of difficulty in the resin selection. However, the following problem has been encountered in the card adaptor 201 shown in FIGS. 24 and 25. Specifically, the securing members 206a of the plurality of the contacts 206 are respectively press-fitted into the press-fitting grooves 203a in the lower case 203 from above, and the press-fitting direction of the securing members 206a is the same as the direction of pressing against the elastic contact members 206b of the contacts 206 by the conductive pads of the small card. Therefore, the variance in the press-fitting positions of the securing members 206a in the press-fitting direction causes variance to be generated easily in the pressing force against the elastic contact members 206b of the contacts 206 by the conductive pads of the small card, i.e., in the contact pressure, so that even with the card adaptor 201 shown in FIGS. 24 and 25, the electrical connection between the small card and the card adaptor 201 is still not established properly in some instances.

### SUMMARY

Accordingly, the present invention was devised in light of these problems; it is an object of the present invention to provide a contact assembly in which variance tends not to be generated in the pressing force against the elastic contact members of the contacts by mating contact members such as conductive pads of a small card, i.e., in the contact pressure, a method for manufacturing the contact assembly, and an electrical connector comprising the contact assembly.

This and other objects are achieved by an electrical connector comprising a contact assembly including an inner housing and a plurality of contacts. The inner housing has a plurality of contact press-fitting openings. Each of the contacts has an elastic contact member for electrically connecting to a card inserted into the electrical connector and a press-fitting member. The press-fitting member is inserted into the contact press-fitting openings in a direction perpendicular to a direction of pressing of the elastic contact members by the card.

This and other objects are further achieved by a method of manufacturing an electrical connector, comprising providing an inner housing a plurality of contact press-fitting openings; providing a plurality of contacts each having an elastic contact member for electrically connecting to a card inserted into the electrical connector and a press-fitting member; and inserting the elastic contact members into the press-fitting openings in a direction perpendicular to a direction of pressing of the elastic contact members by the card to form a contact assembly.

### BRIEF DESCRIPTION OF THE DRAWINGS

FIGS. 1A and 1B show an electrical connector comprising a contact assembly of the present invention, with FIG. 1A being a plan view, and FIG. 1B being a front view;

FIGS. 2A and 2B show the electrical connector of FIGS. 1A and 1B, with FIG. 2A being a left side view, and FIG. 2B being an underside view;

FIGS. 3A and 3B show the contact assembly, with FIG. 3A being a plan view, and FIG. 3B being a front view;

FIGS. 4A and 4B show the contact assembly of FIGS. 3A and 3B, with FIG. 4A being a left side view, and FIG. 4B being a sectional view along line 4B-4B in FIG. 3A;

FIGS. 5A and 5B show an inner housing, with FIG. 5A being a plan view, and FIG. 5B being a front view;

FIGS. 6A, 6B, 6C and 6D show the inner housing of FIG. 5A, with FIG. 6A being a left side view, FIG. 6B being a sectional view along line 6B-6B in FIG. 5A, FIG. 6C being a sectional view along line 6C-6C in FIG. 5A, and FIG. 6D being a rear view;

FIG. 7 is an underside view of the inner housing of FIG. 5;

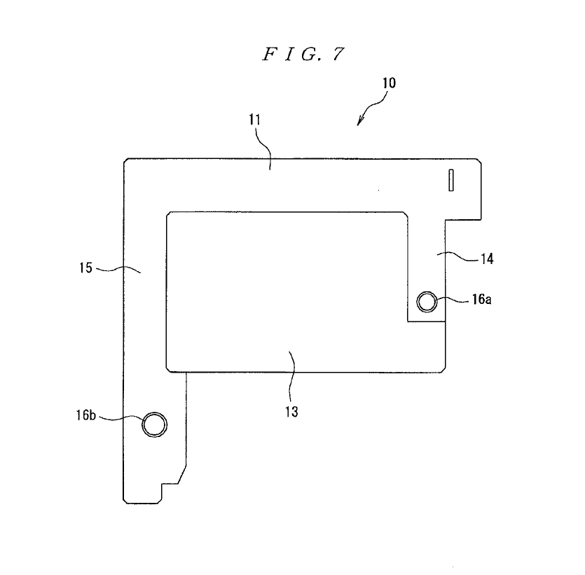

FIGS. 8A and 8B show a contact member in which a plurality of contacts are connected to each other by linking members and formed as an integral unit, with FIG. 8A being a plan view, and FIG. 8B being a front view;

FIGS. 9A and 9B show the contact member of FIGS. 8A and 8B, with FIG. 9A being a left side view, and FIG. 9B being a rear view;

FIG. 10 is a plan view of a state in which a plurality of contact members are linked to a carrier;

FIGS. 11A and 11B show a hook spring, with FIG. 11A being a plan view, and FIG. 11B being a left side view;

FIGS. 12A and 12B show a base housing, with FIG. 12A being a plan view, and FIG. 12B being a front view;

FIGS. 13A, 13B and 13C show the base housing of FIGS. 12A and 12B, with FIG. 13A being a left side view, FIG. 13B being a right side view, and FIG. 13C being a rear view;

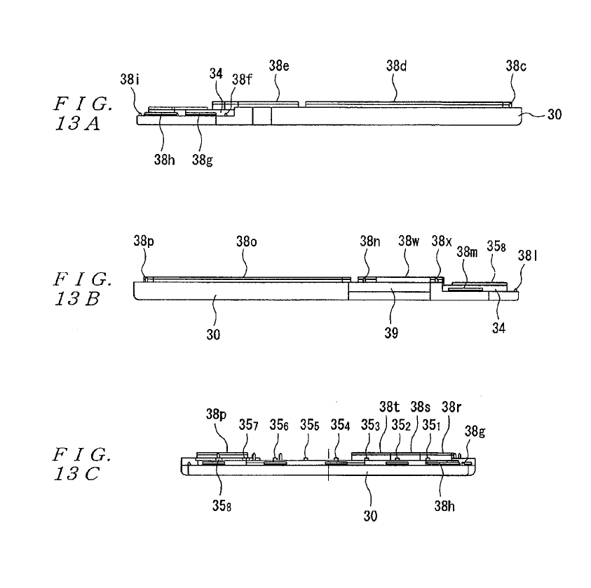

FIGS. 14A, 14B and 14C show the base housing of FIGS. 12A and 12B, with FIG. 14A being a sectional view along line 14A-14A in FIG. 12A, FIG. 14B being a sectional view along line 14B-14B in FIG. 12A, and FIG. 14C being a sectional view along line 14C-14C in FIG. 12A;

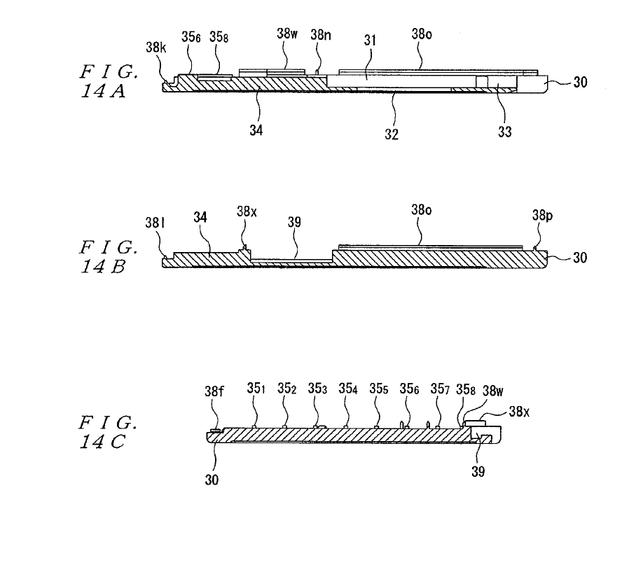

FIG. 15 is an underside view of the base housing of FIG. 12;

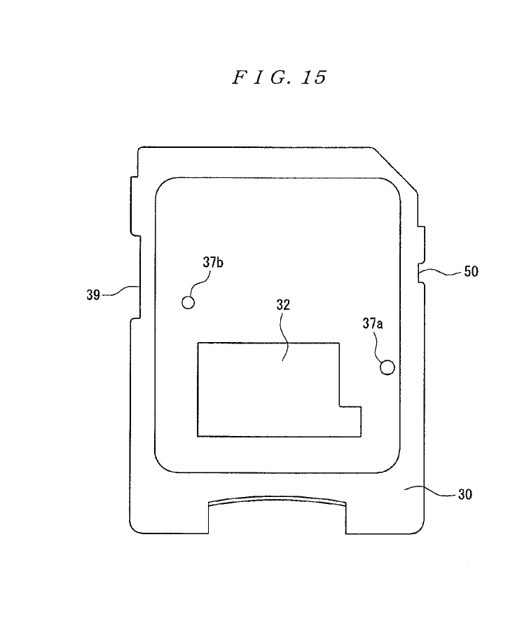

FIGS. 16A and 16B show a cover housing, with FIG. 16A being a plan view, and FIG. 16B being a front view;

FIGS. 17A, 17B and 17C show the cover housing of FIGS. 16A and 16B, with FIG. 17A being a left side view, FIG. 17B being a right side view, and FIG. 17C being a rear view;

FIG. 18 is an underside view of the cover housing of FIG. 16A;

FIGS. 19A, 19B, 19C and 19D show the cover housing of FIGS. 16A and 16B, with FIG. 19A being a sectional view along line 19A-19A in FIG. 18, FIG. 19B being a sectional view along line 19B-19B in FIG. 18, FIG. 19C being a sectional view along line 19C-19C in FIG. 18, and FIG. 19D being a sectional view along line 19D-19D in FIG. 18;

FIGS. 20A and 20B show a subassembly in which the contact assembly is mounted to the base housing, with FIG. 20A being a plan view, and FIG. 20B being a sectional view along line 20B-20B in FIG. 20A;

FIGS. 21A and 21B show an example of a card adaptor according to the prior art, with FIG. 21A being a plan view, and FIG. 21B being a front view;

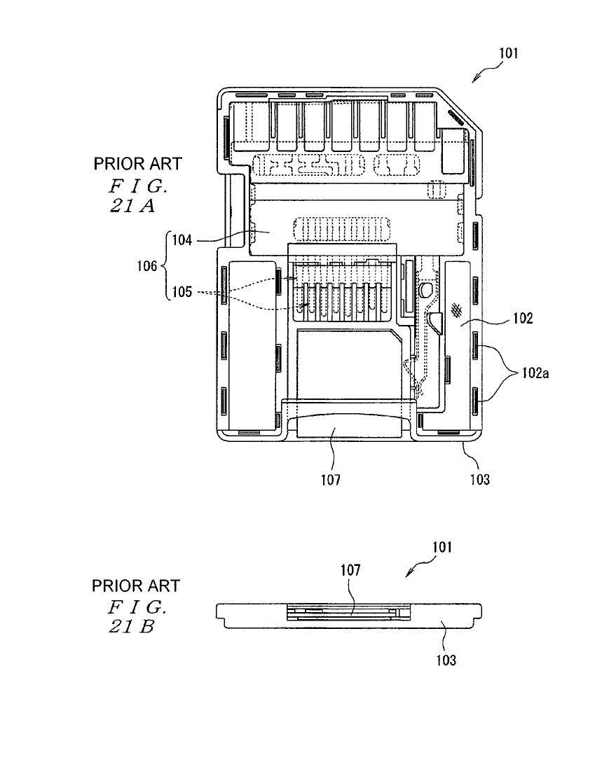

FIG. 22 is a plan view of a state in which a contact assembly according to the prior art is fastened to a lower case;

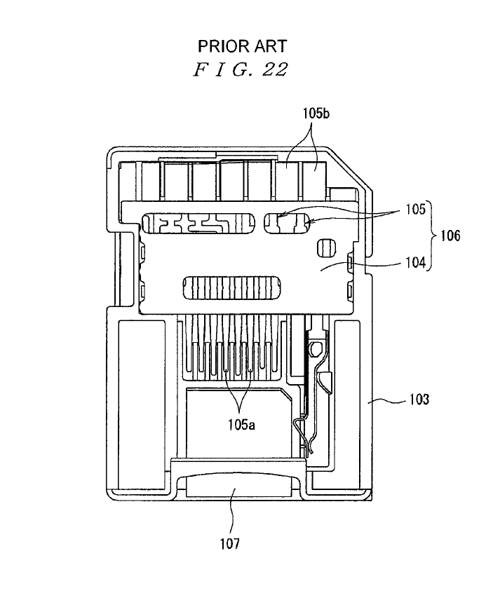

FIG. 23 is a plan view showing the contact assembly according to the prior art together with a card;

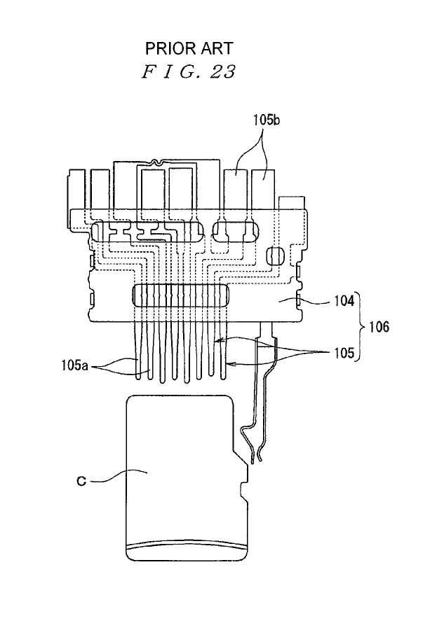

FIG. 24 is an exploded perspective view of another example of a card adaptor according to the prior art; and

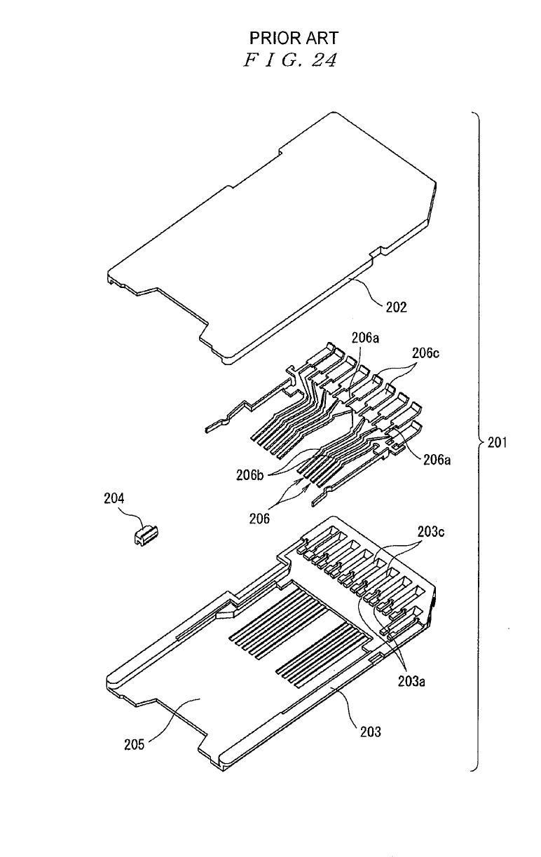

FIG. 25 is a perspective view showing a contact member according to the prior art together with a lower case.

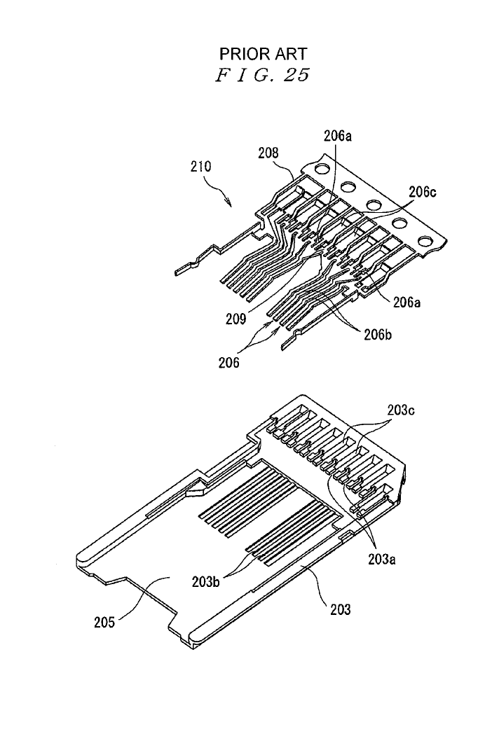

### DETAILED DESCRIPTION OF THE EMBODIMENT(S)

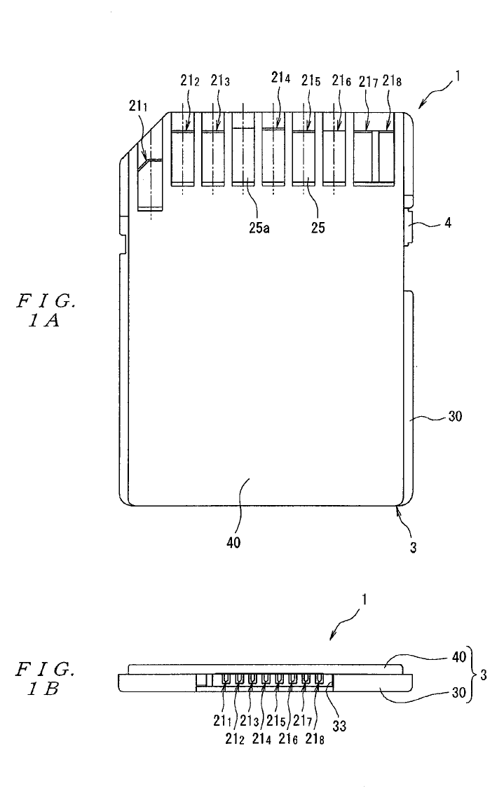

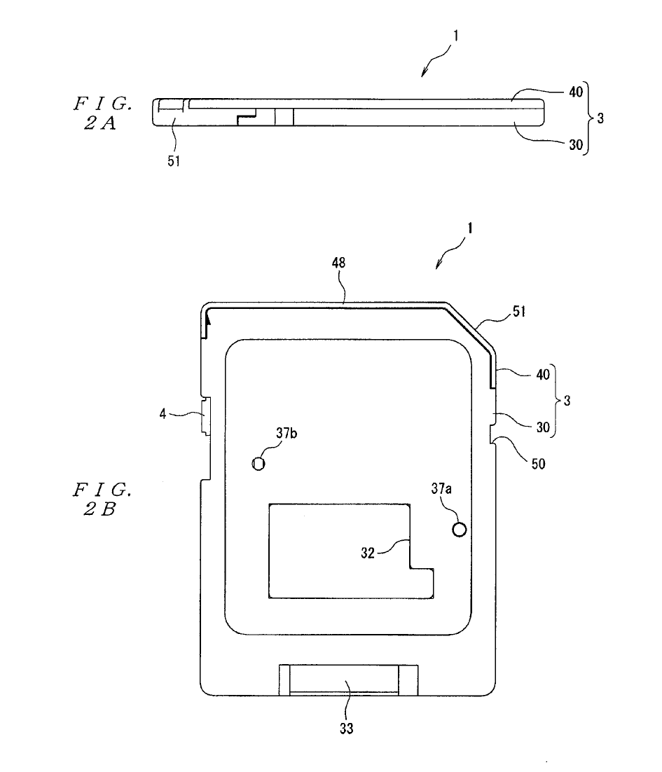

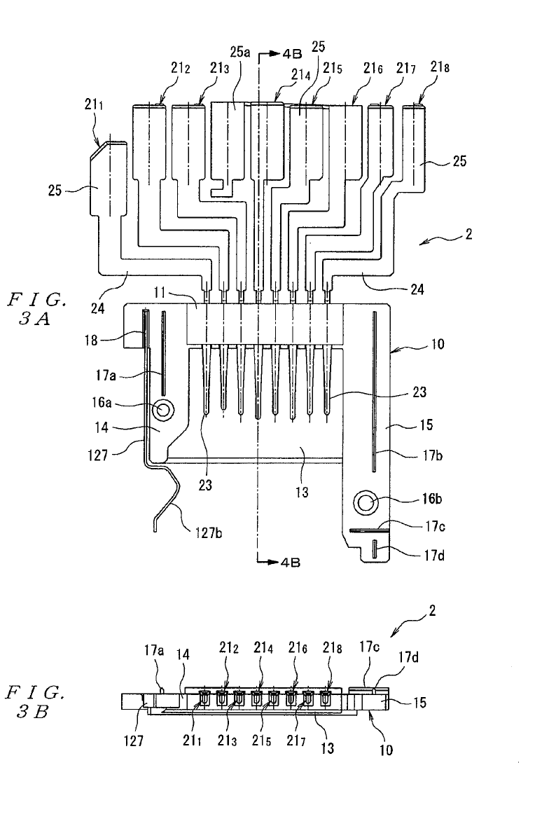

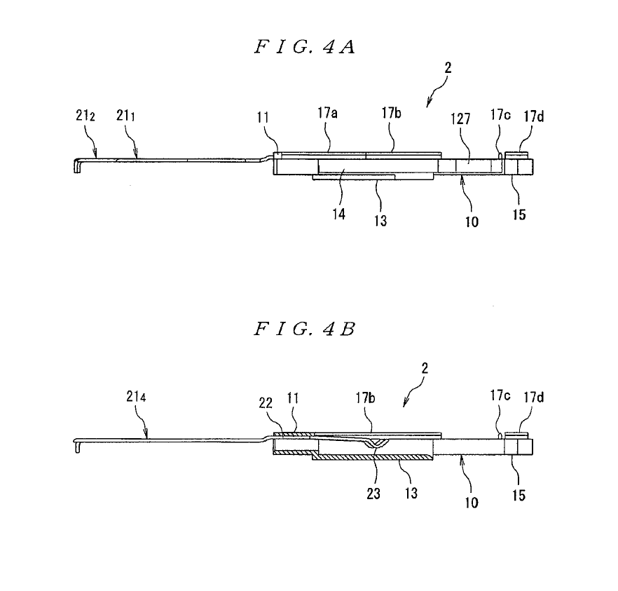

Next, an embodiment of the present invention will be described with reference to the figures. An electrical connector 1 shown in FIGS. 1A, 1B, 2A and 2B is used as a card adaptor for connecting a small card such as a mini SD card (not shown in the figures) to a socket for a large card (not shown in the figures) and comprises a contact assembly 2 shown in FIGS. 3A, 3B, 4A and 4B and an outer housing 3 that accommodates the contact assembly 2 and that consists of a base housing 30 and a cover housing 40.

Here, the contact assembly 2 comprises a plurality of contacts 21₁ through 21₈ (eight contacts in the present embodiment), an inner housing 10 that fastens the contacts 21₁ through 21₈ in parallel to each other, and a hook spring 127.

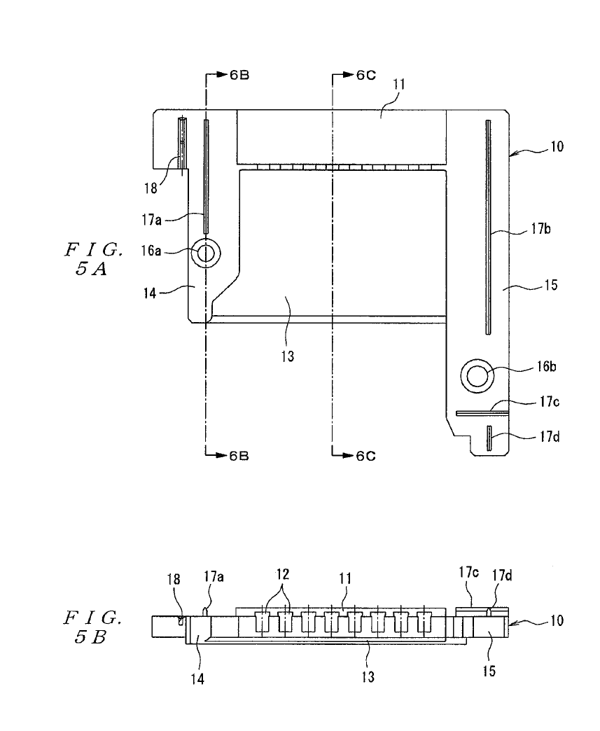

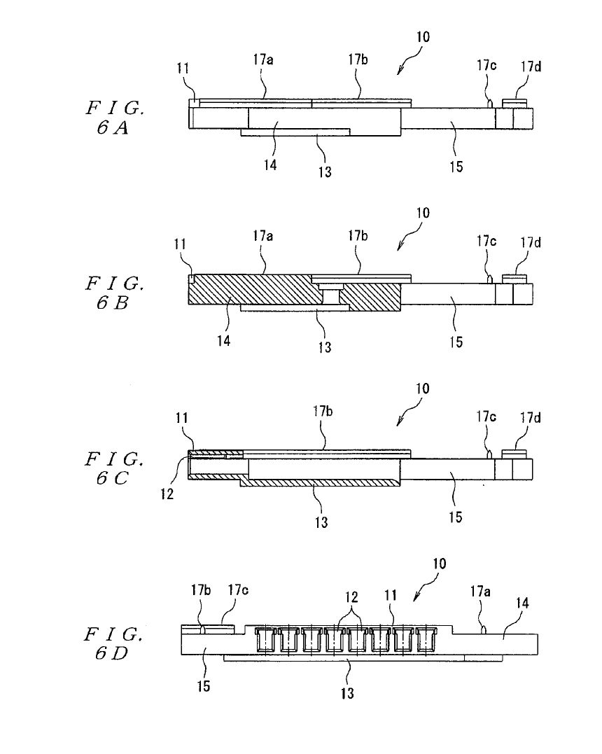

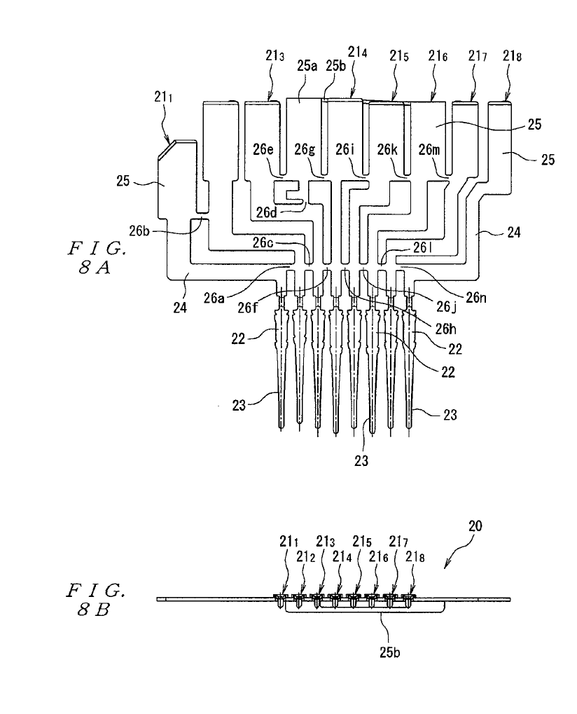

The inner housing 10 is formed in a substantially rectangular shape by molding an insulating resin and comprises a contact securing member 11 that extends in the direction of width (left-right direction in FIG. 5A) as shown in FIGS. 3A through 6D. A plurality of contact press-fitting openings 12 for press-fitting members 22 (see FIG. 8A) of the plurality of contacts 21₁ through 21₈ to be press-fitted are formed in a single row in the contact securing member 11. The contact press-fitting openings 12 are formed near the upper surface of the contact securing member 11 and extend in the forward-rearward direction of the contact securing member 11 (in the vertical direction in FIG. 5A).

Furthermore, a left side wall 14 that extends in the forward direction is provided on the left end portion in the direction of width of the contact securing member 11, and a right side wall 15 that protrudes in the forward direction more than the left side wall 14 is provided on the right end portion in the direction of width of the contact securing member 11. Moreover, a bottom wall 13 that extends in the forward direction up to the front end of the left side wall 14 and that covers the bottom surface of the inner housing 10 is provided on the bottom surface of the contact securing member 11. Here, a first post through-hole 16a that passes through in the vertical direction and a hook spring press-fitting opening 18 that extends in the forward-rearward direction and that is used for the press-fitting of the hook spring 127 are formed in the left side wall 14 of the inner housing 10. In addition, a welding member 17a that extends in the forward-rearward direction is formed in a protruding manner on the upper surface of the left side wall 14. Meanwhile, a second post through-hole 16b that passes through in the vertical direction is formed in the right side wall 15 of the inner housing 10. Furthermore, a welding member 17b that extends in the forward-rearward direction, a welding member 17c that extends in the left-right direction, and a welding member 17d that extends in the forward-rearward direction are formed in a protruding manner on the upper surface of the right side wall 15.

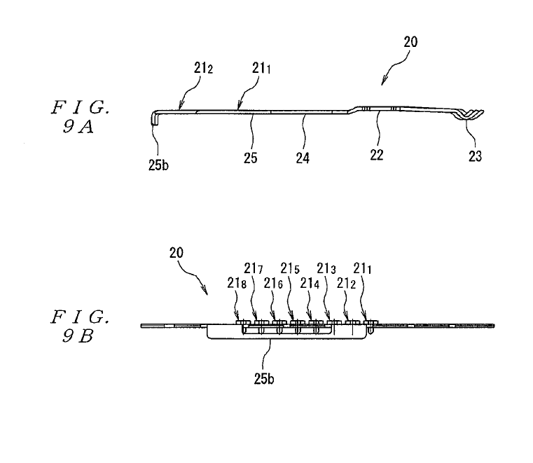

As is shown in FIG. 8A, each of the plurality of contacts 21₁ through 21₈ comprises the press-fitting member 22 that is press-fitted in the contact securing member 11 of the inner housing 10, an elastic contact member 23 that extends forward from the front end of the press-fitting member 22, a linking piece 24 that extends from the rear end of the press-fitting member 22, and a terminal member 25 that is provided at the rear end of the linking piece 24. Moreover, a separate terminal member 25a is connected via a short-circuit member 25b to the terminal member 25 of the contact 21₆ from the left (the terminal member 25 that is seventh from the left including the separate terminal member 25a). The separate terminal member 25a is disposed between the terminal member 25 of the contact 21₃ that is third from the left and the terminal member 25 of the contact 21₄ that is fourth from the left. As shown in FIG. 9(A), each of the elastic contact members 23 has a contact member that extends forward from the front end of the press-fitting member 22 and is then curved into a downward convex shape, so that a conductive pad (mating contact member) provided on the upper surface of the small card such as the mini SD card contacts this contact member. In addition, when the conductive pads respectively make contact with the contact members of the elastic contact members 23, the conductive pads push the contact members upward, so that the contact members are displaced upward with the press-fitting members 22 as fixed ends. Furthermore, the terminal members provided on the socket for the large card with which the electrical connector 1 mates respectively contact the terminal members 25 and the separate terminal member 25a.

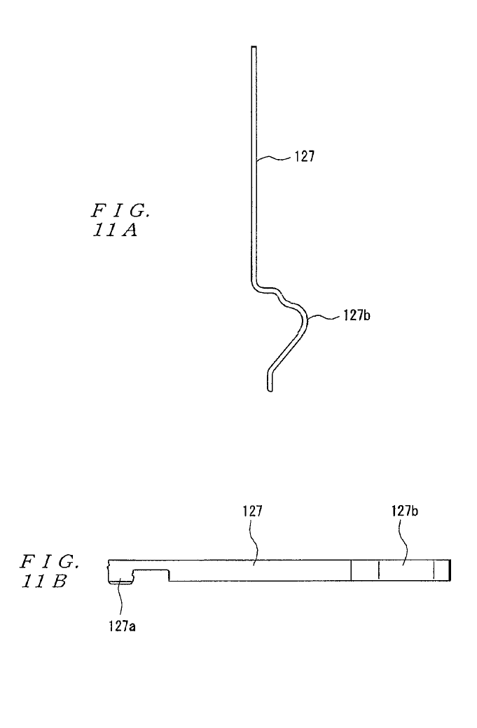

Moreover, the hook spring 127 is formed by stamping and forming a metal plate and is provided with a curved locking member 127b at the front end and a press-fitting member 127a at the rear end as shown in FIGS. 11A and 11B. The press-fitting member 127a is press-fitted, rearward from the front, into the hook spring press-fitting opening 18 formed in the inner housing 10. Furthermore, the curved locking member 127b is formed by bending so as to form an inward convex shape and is locked with a cutout (not shown in the figures) that is formed in one side edge of the small card inserted into the electrical connector 1, thus possessing the function of holding the small card.

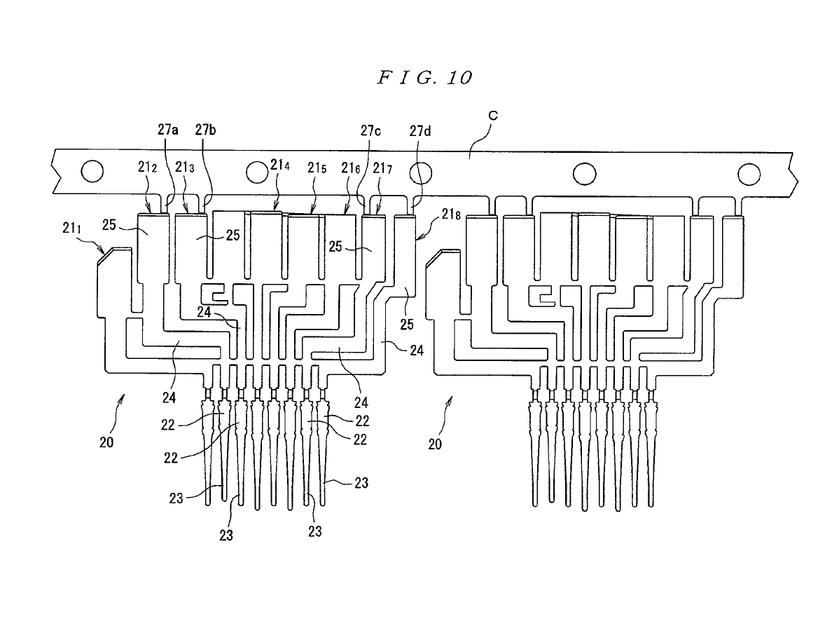

Next, a method for manufacturing the contact assembly 2 will be described with reference to FIGS. 3A, 3B, 8A, 8B and 10. First, a plurality of contact members 20 that are linked to a carrier C are prepared as shown in FIG. 10. This state is formed by stamping and forming a metal plate. Furthermore, as is shown in FIGS. 8A and 10, in each of the contact members 20, the linking piece 24 of the contact 21₁ first from the left and the linking piece 24 of the contact 21₂ second from the left are linked by a linking member 26a, and the terminal member 25 of the contact 21₁ first from the left and the linking piece 24 of the contact 21₂ second from the left are linked by a linking member 26b. Likewise, the linking piece 24 of the contact 21₂ second from the left and the linking piece 24 of the contact 21₃ third from the left are linked by a linking member 26c. Furthermore, the linking piece 24 of the contact 21₃ third from the left and the separate terminal member 25a are linked by a linking member 26d, and the terminal member 25 of the contact 21₃ third from the left and the separate terminal member 25a are linked by a linking member 26e. Moreover, the linking piece 24 of the contact 21₃ third from the left and the linking piece 24 of the contact 21₄ fourth from the left are linked by a linking member 26f, and the separate terminal member 25a and the terminal member 25 of the contact 21₄ fourth from the left are linked by a linking member 26g. In addition, the linking piece 24 of the contact 21₄ fourth from the left and the linking piece 24 of the contact 21₅ fifth from the left are linked by a linking member 26h, and the terminal member 25 of the contact 21₄ fourth from the left and the terminal member 25 of the contact 21₅ fifth from the left are linked by a linking member 26i. Similarly, the linking piece 24 of the contact 21₅ fifth from the left and the linking piece 24 of the contact 21₆ sixth from the left are linked by a linking member 26j, and the terminal member 25 of the contact 21₅ fifth from the left and the terminal member 25 of the contact 21₆ sixth from the left are linked by a linking member 26k. Likewise, the linking piece 24 of the contact 21₆ sixth from the left and the linking piece 24 of the contact 21₇ seventh from the left are linked by a linking member 26l, and the terminal member 25 of the contact 21₆ sixth from the left and the terminal member 25 of the contact 21₇ seventh from the left are linked by a linking member 26m. Moreover, the linking piece 24 of the contact 21₇ seventh from the left and the linking piece 24 of the contact 21₈ eighth from the left are linked by a linking member 26n. Thus, each of the contact members 20 is formed as an integral unit, with the plurality of the contacts 21₁ through 21₈ (eight contacts in the present embodiment) being linked to each other by the linking members 26a through 26n. Furthermore, each of the contact members 20 is formed in the shape of a lead frame formed by stamping and forming a metal plate. Then, each of the contact members 20 is linked to the carrier C by a connecting piece 27a that connects the terminal member 25 of the contact 21₂ second from the left and the carrier C, a connecting piece 27b that connects the terminal member 25 of the contact 21₃ third from the left and the carrier C, a connecting piece 27c that connects the terminal member 25 of the contact 21₇ seventh from the left and the carrier C, and a connecting piece 27d that connects the terminal member 25 of the contact 21₈ eighth from the left and the carrier C.

Next, one of the contact members 20 that are linked to the carrier C is press-fitted in the inner housing 10 in a direction perpendicular to the direction of pressing against the elastic contact members 23 by the conductive pads (mating contact members) provided on the upper surface of the small card, i.e., in the forward direction from the rear of the inner housing 10. In this case, the press-fitting members 22 of the contacts 21₁ through 21₈ are press-fitted into the contact press-fitting openings 12 in the inner housing 10. Thus, because the contact member 20 is press-fitted in the inner housing 10 in a direction perpendicular to the direction of pressing against the elastic contact members 23 by the mating contact members, even if the press-fitting positions of the contacts 21₁ through 21₈ vary in the press-fitting direction (i.e., in the forward-rearward direction), variance is not likely to be generated in the pressing force against the elastic contact members 23 of the contacts 21₁ through 21₈ by the mating contact members, i.e., in the contact pressure. Accordingly, it is possible to provide the contact assembly 2 which can achieve the proper electrical connection between the mating contact members and the contacts 21₁ through 21₈.

Furthermore, there is also a technique in which the contacts 21₁ through 21₈ are welded to the inner housing 10. However, this technique tends to cause variance in the amount of welding of a resin, and it is difficult to control the amount of welding of the resin; therefore, variance is generated easily in the strength for holding the contacts 21₁ through 21₈, and this holding strength also tends to be weakened. Moreover, because the technique based on welding causes variance to be generated easily in the amount of welding, the positional precision of the contacts 21₁ through 21₈ secured to the inner housing 10 is low, resulting in the problem of a low positional precision of the elastic contact members 23. In contrast, if the contact member 20 is press-fitted in the inner housing 10 in a direction perpendicular to the direction of pressing against the elastic contact members 23 by the mating contact members as in the present embodiment, no variance is generated in the strength for holding the contacts 21₁ through 21₈, and this holding strength can also be enhanced. In addition, it is possible to increase the positional precision of the contacts 21₁ through 21₈ secured to the inner housing 10 and to increase the positional precision of the elastic contact members 23 as a result.

Then, the connecting pieces 27a through 27d are cut to separate the carrier C from the contact member 20, and in the contact member 20, the linking members 26a through 26n between the contacts 21₁ through 21₈ are also cut to separate the contacts 21₁ through 21₈. As a result, the plurality of contacts 21₁ through 21₈ (eight contacts in the present embodiment) are attached to the inner housing 10 as shown in FIGS. 3A and 3B.

Thus, in the present embodiment, the plurality of contacts 21₁ through 21₈ are formed as an integral unit by being linked to each other by the linking members 26a through 26n, and the present embodiment includes a step of press-fitting, in the inner housing 10, the contact member 20 in which the contacts 21₁ through 21₈ have the elastic contact members 23 that contact the mating contact members, and a step of cutting the linking members 26a through 26n between the contacts 21₁ through 21₈ of the contact member 20. Accordingly, the manufacturing process can be simplified compared to a case in which the contacts 21₁ through 21₈ are press-fitted separately in the inner housing 10.

Then, by fastening the hook spring 127 to the inner housing 10, the contact assembly 2 is completed. Furthermore, because insert-molding is not necessary in the manufacture of the contact assembly 2, the mold is simple, and the manufacturing cost can be reduced. Moreover, because insert-molding is not necessary, there is no problem of difficulty in the selection of the resin for forming the inner housing 10.

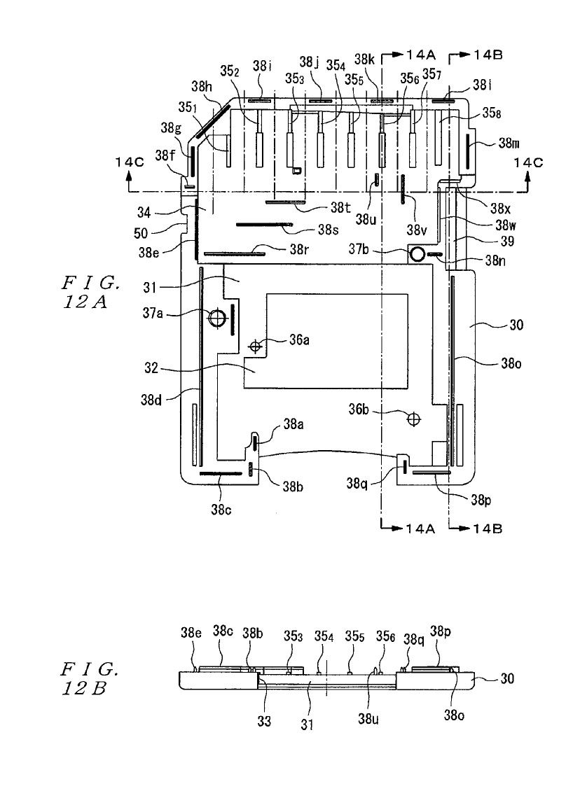

The base housing 30 that partly makes up the outer housing 3 is formed in a substantially rectangular shape by molding an insulating resin, and an inner housing accommodating space 31 for accommodating the inner housing 10 is formed substantially in the central portion as shown in FIG. 12A. A through-hole 32 with which the bottom wall 13 of the inner housing 10 mates is formed in the bottom wall of the inner housing accommodating space 31. Furthermore, a card insertion slot 33 that opens on the front side is formed to the front of the inner housing accommodating space 31, and the upper portions of the inner housing accommodating space 31 and the card insertion slot 33 are open. Moreover, a carrying member 34 on which the linking pieces 24 and the terminal members 25 of the plurality of the contacts 21₁ through 21₈ secured to the inner housing 10 are carried is provided to the rear side of the inner housing accommodating space 31. A plurality of partition walls 35₁ through 35₈ that divide between adjacent terminal members of the terminal members 25 of the contacts 21₁ through 21₈ and the separate terminal member 25a are provided in the area near the rear end portion of this carrying member 34.

A first post 36a that is fitted into the first post through-hole 16a in the inner housing 10 and a second post 36b that is fitted into the second post through-hole 16b are formed in a protruding manner on the bottom wall of the inner housing accommodating space 31 of the base housing 30. Furthermore, a third post through-hole 37a and a fourth post through-hole 37b are respectively formed in the left and right side wall members of the base housing 30. Moreover, two welding members 38a and 38b that extend in the forward-rearward direction and a welding member 38c that extends in the left-right direction are formed in a protruding manner on the upper surface of the front wall that is positioned to the left side of the card insertion slot 33 of the base housing 30.

Two welding members 38d and 38e that extend in the forward-rearward direction are formed in a protruding manner on the upper surface of the left side wall of the base housing 30. Furthermore, a welding member 38f that extends in the left-right direction, a welding member 38g that extends in the forward-rearward direction, a welding member 38h that extends in a diagonal direction, four welding members 38i, 38j, 38k, and 38l that extend in the left-right direction, and a welding member 38m that extends in the forward-rearward direction are formed in a protruding manner on the upper surface of the base housing 30 in the area around the carrying member 34. Moreover, a welding member 38n that extends in the left-right direction and a welding member 38o that extends in the forward-rearward direction are formed in a protruding manner on the upper surface of the right side wall of the base housing 30. In addition, a welding member 38p that extends in the left-right direction and a welding member 38q that extends in the forward-rearward direction are formed in a protruding manner on the upper surface of the front wall that is positioned to the right side of the card insertion slot 33 of the base housing 30. Furthermore, three welding members 38r, 38s, and 38t that extend in the left-right direction and two welding members 38u and 38v that extend in the forward-rearward direction are formed in a protruding manner on the upper surface of the carrying member 34 of the base housing 30.

A tab accommodating recessed member 39 for accommodating a protection tab 4 is formed in the right side wall of the base housing 30. In addition, an engagement recessed member 50 with which a mating locking member engages when the electrical connector 1 mates with a socket for the large card is formed in the left side wall of the base housing 30. Furthermore, a tab accommodating recessed member 39 for accommodating a protection tab 4 is formed in the right side wall of the base housing 30.

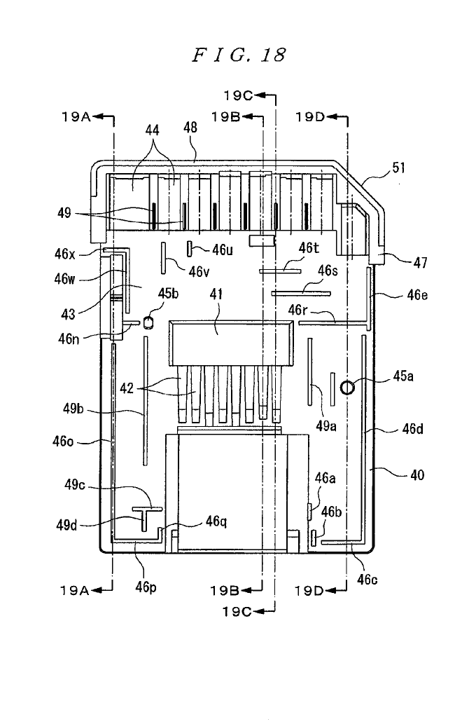

The cover housing 40 that partly makes up the outer housing 3 is formed in a rectangular shape that substantially overlaps with the base housing 30 by molding an insulating resin, and is designed to be superimposed on the base housing 30 and welded after the contact assembly 2 is placed on the base housing 30 and to accommodate the contact assembly 2 together with the base housing 30. As is shown in FIG. 18, the cover housing 40 is provided, in substantially the central portion thereof, with a contact securing recessed member 41 that covers the contact securing member 11 of the inner housing 10 accommodated in the base housing 30 when this cover housing 40 is welded to the base housing 30.

A plurality of contact recessed members 42 that respectively cover the elastic contact members 23 of the plurality of the contacts 21₁ through 21₈ accommodated in the base housing 30 when the cover housing 40 is welded to the base housing 30 are formed to the front side of the contact securing recessed member 41. In addition, a push-in member 43 that pushes in the linking pieces 24 of the plurality of the contacts 21₁ through 21₈ accommodated in the base housing 30 when the cover housing 40 is welded to the base housing 30 is provided to the rear side of the contact securing recessed member 41. Furthermore, a plurality of openings 44 for exposing the terminal members 25 of the plurality of the contacts 21₁ through 21₈ accommodated in the base housing 30 when the cover housing 40 is welded to the base housing 30 are formed to the rear side of the push-in member 43. Moreover, a third post 45a that is fitted into the third post through-hole 37a in the base housing 30 and a fourth post 45b that is fitted into the fourth post through-hole 37b when the cover housing 40 is superimposed on the base housing 30 are formed on the cover housing 40 in a protruding manner.

In addition, the cover housing 40 is provided with a plurality of welding recessed members 46a, 46b, 46c, 46d, 46e, 46n, 46o, 46p, 46q, 46r, 46s, 46t, 46u, 46v, 46w, and 46x where the apexes of the plurality of the welding members 38a, 38b, 38c, 38d, 38e, 38n, 38o, 38p, 38q, 38r, 38s, 38t, 38u, 38v, 38w, and 38x that are formed on the base housing 30 in a protruding manner respectively enter when the cover housing 40 is superimposed on the base housing 30. The cover housing 40 is also provided with a base seat member 47 which is contacted by the apexes of the welding members 38f, 38g, 38h, 38i, 38j, 38k, 38l, and 38m that are formed in a protruding manner on the upper surface of the base housing 30 in the area around the carrying member 34 when the cover housing 40 is superimposed on the base housing 30. Furthermore, a covering member 48 that covers the rear end edge of the base housing 30 when the cover housing 40 is welded to the base housing 30 is provided on the rear end edge of base seat member 47. Moreover, an inclined surface 51 for preventing the reverse insertion is provided at the left corner portion of the covering member 48. In addition, the cover housing 40 is provided with welding recessed members 49a, 49b, 49c, and 49d where the apexes of the welding members 17a, 17b, 17c, and 17d formed in a protruding manner on the inner housing 10 respectively enter when the cover housing 40 is superimposed on the base housing 30.

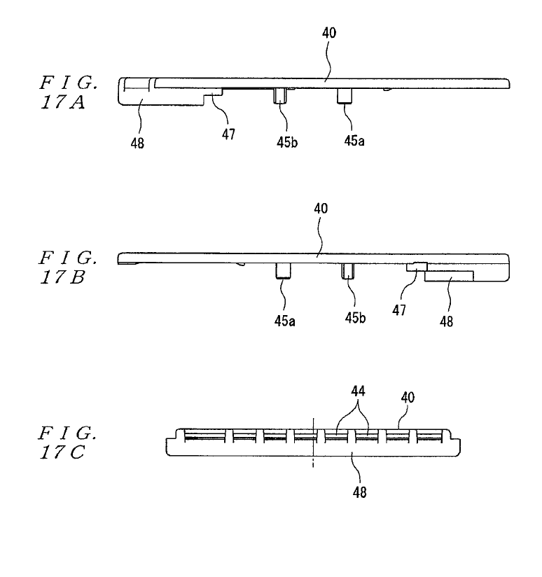

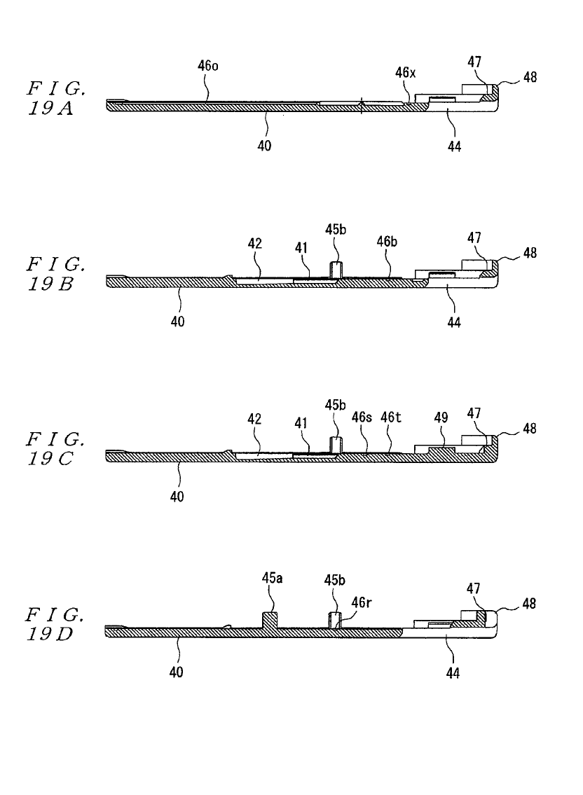

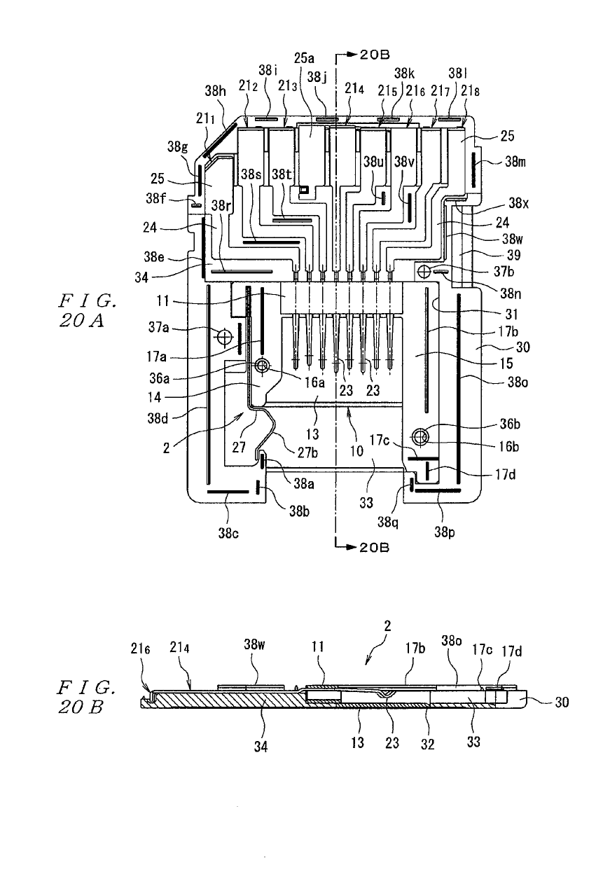

Next, a method for manufacturing the electrical connector 1 will be described with reference to FIGS. 1A, 1B, 2A, 2B, 3A, 3B, and 16A through 20B. First, the contact assembly 2 shown in FIGS. 3A and 3B is manufactured using the method described above. Next, the contact assembly 2 is placed on the base housing 30 as shown in FIGS. 20A and 20B. In this case, the inner housing 10 of the contact assembly 2 is accommodated in the inner housing accommodating space 31 in the base housing 30 while performing positioning by inserting the first post 36a of the base housing 30 into the first post through-hole 16a in the inner housing 10 and inserting the second post 36b into the second post through-hole 16b. Then, the bottom wall 13 of the inner housing 10 is caused to mate with the through-hole 32 in the base housing 30, and the undersurface of the base housing 30 and the undersurface of the inner housing 10 become coplanar. Meanwhile, when the contact assembly 2 is placed on the base housing 30, the linking pieces 24 and the terminal members 25 of the contacts 21₁ through 21₈ and the separate terminal member 25a are placed on the carrying member 34 of the base housing 30. Here, the spaces between adjacent terminal members of the terminal members 25 and the separate terminal member 25a are respectively divided by the plurality of the partition walls 35₁ through 35₈. Then, the ultrasonic welding of the first post 36a and the second post 36b of the base housing 30 is performed, thus fastening the inner housing 10 to the base housing 30.

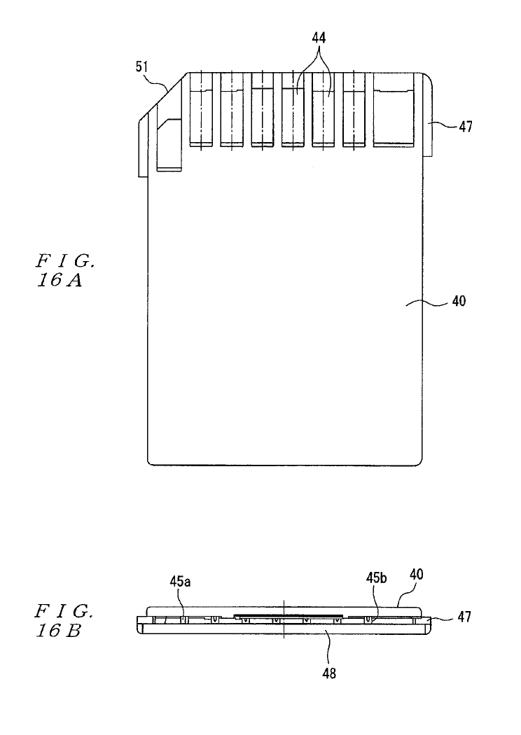

Furthermore, the cover housing 40 shown in FIGS. 16A through 19D is superimposed on the base housing 30. In this case, the third post 45a of the cover housing 40 is fitted into the third post through-hole 37a in the base housing 30, and the fourth post 45b is fitted into the fourth post through-hole 37b, thus positioning the cover housing 40 with respect to the base housing 30. Then, when the cover housing 40 is superimposed on the base housing 30, the apexes of the plurality of the welding members 38a, 38b, 38c, 38d, 38e, 38n, 38o, 38p, 38q, 38r, 38s, 38t, 38u, 38v, 38w, and 38x that are formed on the base housing 30 in a protruding manner respectively enter the plurality of welding recessed members 46a, 46b, 46c, 46d, 46e, 46n, 46o, 46p, 46q, 46r, 46s, 46t, 46u, 46v, 46w, and 46x of the cover housing 40. Moreover, the apexes of the welding members 38f, 38g, 38h, 38i, 38j, 38k, 38l, and 38m that are formed in a protruding manner on the upper surface of the base housing 30 in the area around the carrying member 34 contact the base seat member 47 of the cover housing 40. In addition, the apexes of the welding members 17a, 17b, 17c, and 17d formed on the inner housing 10 in a protruding manner respectively enter the welding recessed members 49a, 49b, 49c, and 49d of the cover housing 40.

Finally, the third post 45a and the fourth post 45b of the cover housing 40, the welding members 38a through 38x of the base housing 30, and the welding members 17a through 17d of the inner housing 10 are ultrasonic welded, thus fastening the cover housing 40 to the base housing 30 and the inner housing 10. As a result, the contact assembly 2 is accommodated in the outer housing 3 constructed from the base housing 30 and the cover housing 40, and the electrical connector 1 shown in FIGS. 1A through 2B is completed.

Furthermore, when the cover housing 40 is welded to the base housing 30, the contact securing recessed member 41 of the cover housing 40 covers the contact securing member 11 of the inner housing 10. Moreover, the plurality of contact recessed members 42 of the cover housing 40 respectively cover the elastic contact members 23 of the plurality of the contacts 21₁ through 21₈. In addition, the push-in member 43 of the cover housing 40 pushes in the linking pieces 24 of the plurality of the contacts 21₁ through 21₈, so that the terminal members 25 provided at the rear ends of the linking pieces 24 are prevented from floating from the base housing 30. Furthermore, the terminal members 25 of the plurality of contacts 21₁ through 21₈ and the separate terminal member 25a are exposed to the plurality of the openings 44 in the cover housing 40 as shown in FIG. 1(A), making it possible for the terminal members provided on the socket for the large card with which the electrical connector 1 mates to contact the terminal members 25 and the separate terminal member 25a via the openings 44.

The electrical connector 1 that has been assembled in this manner mates with the socket for the large card, and the terminal members provided on the socket contact the terminal members 25 of the plurality of the contacts 21₁ through 21₈ and the separate terminal member 25a, thus establishing an electrical connection. Meanwhile, the small card is inserted into the card insertion slot 33 in the electrical connector 1, and the conductive pads (mating contact members) provided on the upper surface of the small card respectively contact the elastic contact members 23 of the contacts 21₁ through 21₈. As a result, the small card is electrically connected to the socket for the large card via the contacts 21₁ through 21₈.

An embodiment of the present invention has been described above. However, the present invention is not limited to this embodiment, and various alterations and modifications can be made. For example, the contact assembly 2 may also be used in a device other than the electrical connector 1 used as a card adaptor for connecting the small card such as the mini SD card to the socket for the large card.

What is claimed is:

1-4. (canceled)

5. An electrical connector, comprising:
a contact assembly including an inner housing and a plurality of contacts;
the inner housing having a plurality of contact press-fitting openings; and
each of the contacts having an elastic contact member for electrically connecting to a card inserted into the electrical connector and a press-fitting member, the press-fitting member being inserted into the contact press-fitting openings in a direction perpendicular to a direction of pressing of the elastic contact members by the card.

6. The electrical connector of claim 5, wherein the elastic contact members extend from the press-fitting members and have a curved downward convex shape at an end thereof.

7. The electrical connector of claim 5, wherein each of the contacts has a contact terminal member provided at an end of the contact opposite from the elastic contact member for electrically contacting another card.

8. The electrical connector of claim 5, further comprising a base housing that accommodates the contact assembly.

9. The electrical connector of claim 8, wherein an undersurface of the inner housing and an undersurface of the base housing are coplanar.

10. The electrical connector of claim 9, wherein a bottom wall of the inner housing arranged opposite the elastic contact members is received in an inner housing accommodating space in the base housing.

11. The electrical connector of claim 8, further comprising a cover housing superimposed on the base housing.

12. The electrical connector of claim 8, wherein the base housing has a carrying member for supporting at least a portion of the contacts.

13. The electrical connector of claim 5, wherein the contacts are provided with removable linking members.

14. A method of manufacturing an electrical connector, comprising:
providing an inner housing a plurality of contact press-fitting openings;
providing a plurality of contacts each having an elastic contact member for electrically connecting to a card inserted into the electrical connector and a press-fitting member; and
inserting the elastic contact members into the press-fitting openings in a direction perpendicular to a direction of pressing of the elastic contact members by the card to form a contact assembly.

15. The method of claim 14, wherein the elastic contact members extend from the press-fitting members and have a curved downward convex shape at an end thereof.

16. The method of claim 14, wherein each of the contacts has a contact terminal member provided at an end of the contact opposite from the elastic contact member for electrically contacting another card.

17. The method of claim 14, further comprising providing a base housing that accommodates the contact assembly.

18. The method of claim 17, wherein an undersurface of the inner housing and an undersurface of the base housing are coplanar.

19. The method of claim 18, wherein a bottom wall of the inner housing arranged opposite the elastic contact members is received in an inner housing accommodating space in the base housing.

20. The method of claim 17, further comprising superimposing a cover housing on the base housing.

21. The method of claim 17, wherein the base housing has a carrying member for supporting at least a portion of the contacts.

22. The method of claim 14, further comprising removing linking members connecting each of the contacts.
